(19) United States
(12) Patent Application Publication
(10) Pub. No.: US 2009/0317070 A1
(43) Pub. Date: Dec. 24, 2009

(54) Digital Image Copier For Photos, Films, And Slides

(76) Inventor: Paul Liu, Taipei (TW)

Correspondence Address: WPAT, PC;INTELLECTUAL PROPERTY ATTORNEYS, 2030 MAIN STREET, SUITE 1300, IRVINE, CA, 92614, US

(21) Appl. No.: 12/141,374

(22) Filed: Jun. 18, 2008

(51) Int. Cl. G03B 15/04; G03B 17/00

(52) U.S. Cl. 396/155; 396/419

(57) ABSTRACT

A digital image copier for photos, films and slides is provided. The digital image copier includes: a housing being a hollow body; a feeding slot disposed in the housing and bridged between a front side and a rear side of the housing, for feeding the photos, films and slides therein; a digital camera disposed inside the housing and facing to the feeding slot for shooting a picture of the photos, films and slides; and at least one light source disposed inside the housing for irradiating the photos, films and slides to provide the digital camera with a better shooting. The picture captured by the digital camera is converted into a digital image file that can be stored on an external storage device.

### BACKGROUND OF THE INVENTION

1. Field of the Invention

The present invention generally relates to a digital image copier, and more particularly to a digital image copier for photos, films, and slides.

2. The Prior Arts

Conventional cameras have been gradually substituted by digital cameras since the digital cameras were invented. Images captured by the conventional cameras are first recorded on films, and then can be shown to viewers via photos or slides. However, images captured by the digital cameras are first converted into a digital image file and stored in a storage device, which then can be shown to viewers directly via an image display device, or via photos or slides. The digital image files are very convenient for storage and showing to the viewers. Furthermore, common people have scarcely used the conventional cameras recently. The maintenance of the conventional old films, photos and slides captured by the conventional cameras is an urgent problem to be solved.

Therefore, many people are undergoing renovation of the old films, photos and slides by the digital cameras, and then converting them into digital image files so as to be stored easily. However, in order to seek for promoting the renovated image quality of the old films, photos and slides, that should be taken or renovated by professional photographers; thereby it is very time-consuming and high costs.

Hence, it is desired to design a digital image copier that can easily convert the conventional old films, photos and slides into a digital image file so as to be stored easily.

### SUMMARY OF THE INVENTION

A primary objective of the present invention is to provide a digital image copier for photos, films and slides, which can directly convert conventional old photos, films and slides into a digital image file without the assistance of a professional photographer, so as to be stored easily.

In order to achieve the above-mentioned objective, a digital image copier for photos, films and slides according to the present invention includes a housing being a hollow body; a feeding slot disposed in the housing and bridged between a front side and a rear side of the housing, for feeding the photos, films and slides therein; a digital camera disposed inside the housing and facing to the feeding slot for shooting a picture of the photos, films and slides; and at least one light source disposed inside the housing for irradiating the photos, films and slides to provide the digital camera with a better shooting. The picture captured by the digital camera is converted into a digital image file that can be stored on an external storage device.

According to the present invention, the digital image copier for photos, films and slides can easily and directly convert, without the assistance of professional photographers, the conventional old photos, films and slides into a digital image file that can be stored in an external storage device; thereby saving much time and cost.

### BRIEF DESCRIPTION OF THE DRAWING

The present invention will be apparent to those skilled in the art by reading the following detailed description of a preferred embodiment thereof, with reference to the attached drawings, in which:

FIG. 1 is a perspective view showing a digital image copier according to the present invention;

FIG. 2 is a schematic view showing the operation of the digital image copier according to an embodiment of the present invention;

FIG. 3 is a schematic view showing the operation of the digital image copier according to another embodiment of the present invention;

FIG. 4 is a schematic view showing that a photo is to be inserted into a feeding slot of the digital image copier according to one embodiment of the present invention; and

FIG. 5 is a schematic view showing that a film placed on a holder is inserted in the digital image copier according to another embodiment of the present invention.

### DETAILED DESCRIPTION OF THE PREFERRED EMBODIMENT

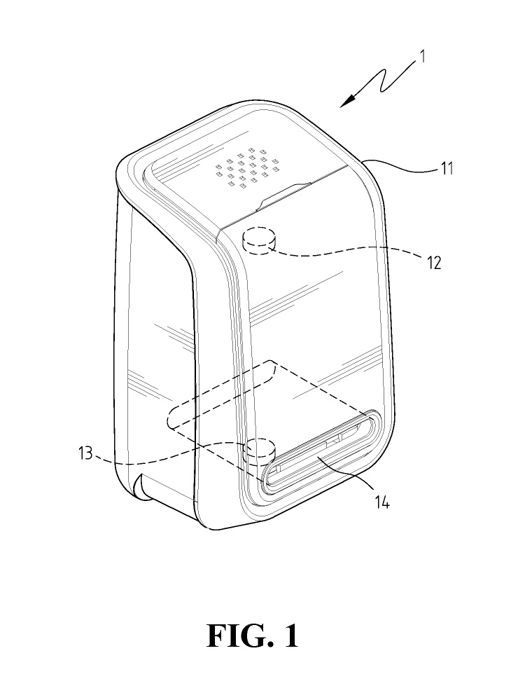

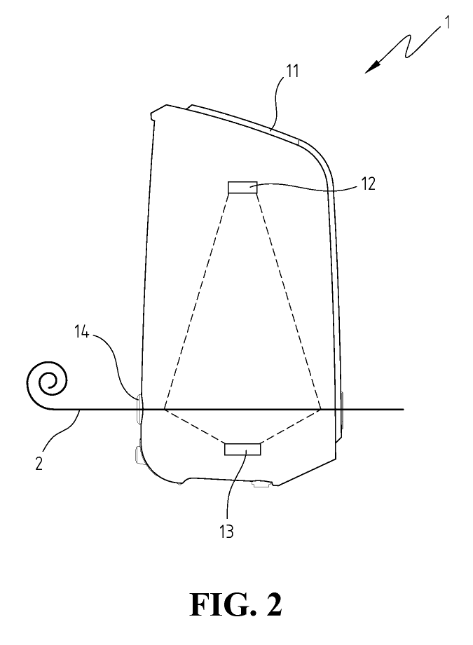

Referring to FIG. 1, a digital image copier 1 according to the present invention includes a housing 11, a feeding slot 14 disposed in the housing 11 and bridged between a front side and a rear side of the housing 11 for feeding an object such as a photo, a film or a slide therein, a digital camera 12 disposed inside the housing 11 and facing to the feeding slot 14 for shooting a picture of the object, and a light source 13 disposed inside the housing 11 for irradiating the object to provide the digital camera 12 with a better shooting. The housing 11 is a hollow body. The digital camera 12 and the light source 13 are respectively arranged in an upper side and a lower side of the feeding slot 14. In operation, an object 2, such as a photo, a film or a slide, is inserted into a designed position of the feeding slot 14 (see FIG. 2); the light source 13 irradiates the object 2 and then the digital camera 12 shoots a picture of the object 2. Thereafter, the shot picture is converted into a digital image file that can be stored on an external storage device, such as a computer or a hard disk.

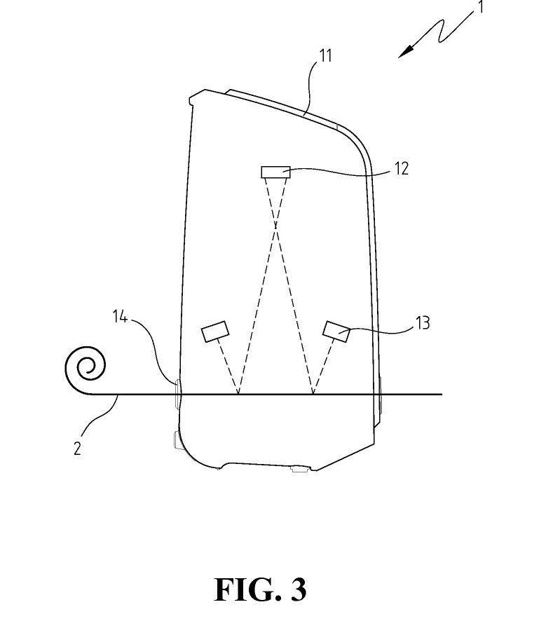

Referring to FIGS. 2 and 3, the digital camera 12 is arranged over the feeding slot 14. The light source 13 may be arranged on a same side as and/or different sides from the digital camera 12 in relative to the feeding slot 14, which are determined by the object 2 to be shot. In order to promote the image capture quality, the number of the light source 13 can be adjusted according to actual desires. Preferably, it is one to six light sources.

In accordance with an embodiment of the present invention, if the object 2 is a transparent object, such as a film or a slide, the light source 13 is arranged under the feeding slot 14 and faces to the digital camera 12; namely, the feeding slot 14 is positioned between the digital camera 12 and the light source 13. At the time of the light source 13 irradiating the object 2, the digital camera 12 shoots a picture of the object 2, which is then recorded on the external storage device in the form of a digital image file.

In accordance with another embodiment of the present invention, if the object 2 is an opaque object, such as a photo, the light source 13 is arranged on the same side as the digital camera 12 in relative to the feeding slot 14 but lower than the digital camera 12, and the light source 13 faces to the feeding slot 14; namely, the light source 13 is positioned between the feeding slot 14 and the digital camera 12. At the time of the light source 13 irradiating the object 2, the digital camera 12 shoots a picture of the object 2, which is then recorded on the external storage device in the form of a digital image file.

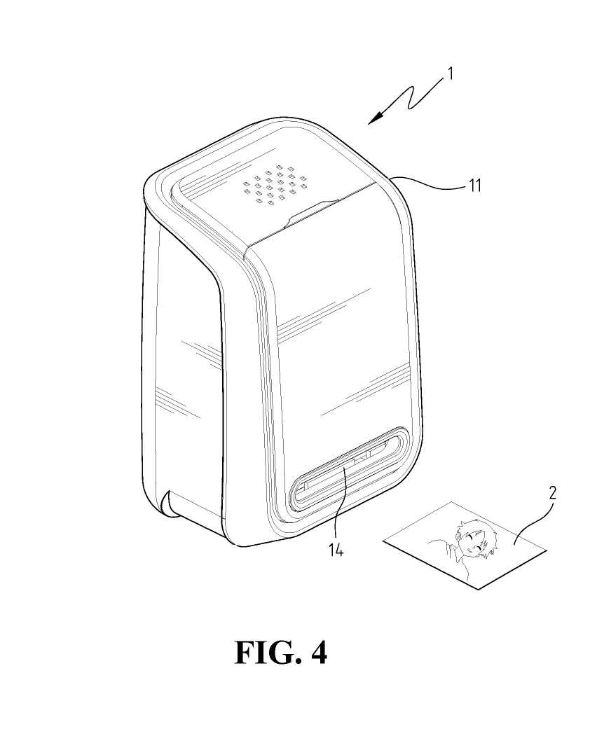

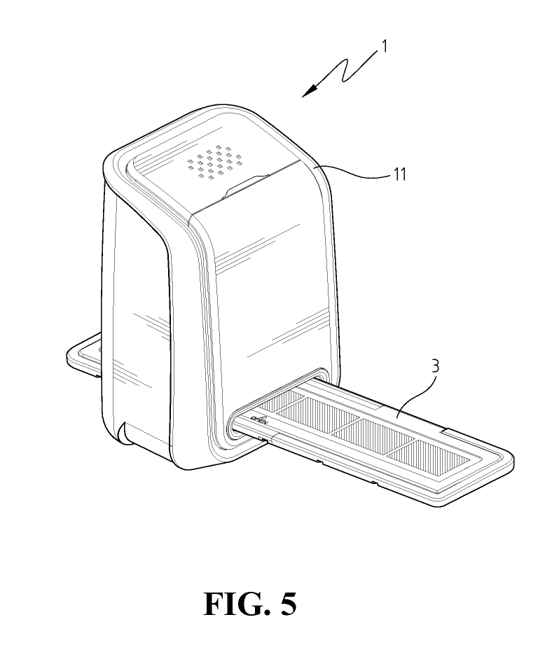

Please refer to FIG. 4, which is a schematic view showing that a photo can be directly inserted into the digital image copier according to an embodiment of the present invention. Referring to FIG. 5, the digital image copier 1 according to another embodiment of the present invention further includes a holder 3 adapted for holding an object 2 that is an easily crimped or a smaller one, such as a film or a slide, so as to be able to be conveniently inserted into the feeding slot 14.

Although the present invention has been described with reference to the preferred embodiment thereof, it is apparent to those skilled in the art that a variety of modifications and changes may be made without departing from the scope of the present invention which is intended to be defined by the appended claims.

What is claimed is:

1. A digital image copier for photos, films and slides, comprising:
a housing being a hollow body;
a feeding slot disposed in the housing and bridged between a front side and a rear side of the housing, for feeding the photos, films and slides therein;
a digital camera disposed inside the housing and facing to the feeding slot for shooting a picture of the photos, films and slides; and
at least one light source disposed inside the housing for irradiating the photos, films and slides to provide the digital camera with a better shooting.

2. The digital image copier as claimed in claim 1, wherein each light source is arranged on a different side from the digital camera in relative to the feeding slot, and the light source faces to the digital camera.

3. The digital image copier as claimed in claim 1, wherein each light source is arranged on a same side as the digital camera in relative to the feeding slot, and the light source faces to the feeding slot.

4. The digital image copier as claimed in claim 1, wherein the number of the light source is preferably one of one to six light sources.

5. The digital image copier as claimed in claim 1, further comprising a holder adapted for holding the photos, films and slides, so as to be conveniently inserted into the feeding slot.
